(19) United States
(12) Patent Application Publication
(10) Pub. No.: US 2008/0212907 A1
(43) Pub. Date: Sep. 4, 2008

(54) HYDRODYNAMIC BEARING, AND HYDRODYNAMIC BEARING-TYPE ROTARY DEVICE AND RECORDING AND REPRODUCING APPARATUS EQUIPPED WITH SAME

(76) Inventors: Takafumi Asada, Osaka (JP); Hiroaki Saito, Ehime (JP); Daisuke Ito, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/031,199

(22) Filed: Feb. 14, 2008

(30) Foreign Application Priority Data
Mar. 2, 2007 (JP) 2007-52472

(51) Int. Cl. F16C 32/06

(52) U.S. Cl. 384/112

(57) ABSTRACT

The angular stiffness of a bearing is kept high, and at the same time air inside the bearing is discharged smoothly, without accumulating, which prevents oil film separation on the bearing. With the present invention, a communicating hole is provided, the hole and a radial hydrodynamic groove constitute a circulation path for a lubricant, there is a first thrust bearing face in contact with the circulation path, there is a first hydrodynamic groove on the face, this groove is a herringbone groove with a pump-in pattern, and no low-pressure part is generated in the thrust bearing, so even if the bearing undergoes a pressure change, there is no risk that the air accumulated in a low-pressure part will expand and cause oil film separation on the bearing face. Also, the bubbles are smoothly discharged by circulation of the lubricant in the asymmetrical radial hydrodynamic groove, and there is a pressure distribution such that the pressure generated at the face during bearing rotation is sufficiently high at the outer peripheral portion of the groove pattern, and angular stiffness is high.

### TECHNICAL FIELD

The present invention relates to a hydrodynamic bearing, and to a hydrodynamic bearing-type rotary device and a recording and reproducing apparatus equipped with this hydrodynamic bearing.

### BACKGROUND ART

In recent years recording devices and so forth that make use of a rotating disk have been increasing in memory capacity, and their data transfer rate has also been rising. Therefore, the bearings used in these recording apparatuses are needed to have high performance and reliability in order to keep the disk load rotating constantly at high precision. For this reason, hydrodynamic bearings, which are suited to high-speed rotation, have been used in these rotary devices.

An example of a conventional hydrodynamic bearing-type rotary device will now be described through reference to FIGS. 13 to 17.

As shown in FIG. 13, a conventional hydrodynamic bearing-type rotary device comprises a sleeve 21, a shaft 22, a flange 23, a thrust plate 24, a seal cap 25, a lubricating fluid (oil) 26, a hub 27, a base 28, a rotor magnet 29, and a stator 30.

The shaft 22 is integrated with the flange 23, and is inserted in a rotatable state into a bearing hole 21A of the sleeve 21. The flange 23 is accommodated in a step part 21C of the sleeve 21. A radial hydrodynamic groove 21B is formed in the outer peripheral face of the shaft 22 and/or the inner peripheral face of the sleeve 21. Meanwhile, a first thrust hydrodynamic groove 23A is formed in an opposing face between the flange 23 and the thrust plate 24. A second thrust hydrodynamic groove 23B is formed in the face of the flange 23 across from the sleeve 21. The thrust plate 24 is affixed to the sleeve 21 or the base 28. At least the bearing gaps near the hydrodynamic grooves 21B, 23A, and 23B are filled with the oil 26. Also, the entire pocket-shaped space formed by the sleeve 21, the shaft 22, and the thrust plate 24 is filled with the oil 26 as necessary. The seal cap 25 has a fixed part 25A attached near the upper end face of the sleeve 21, and also has a tapered part 25B and a vent hole 25C. A communicating passage 21G is provided substantially parallel to the bearing hole 21A. Also, the communicating passage 210 is provided so as to link a lubricating fluid reservoir (oil reservoir) of the seal cap 25 with the area around the outer periphery of the flange 23. The communicating passage 21Q the radial hydrodynamic groove 21B, and the thrust hydrodynamic groove 23B constitute the circulation path of the oil 26. Also, bubbles 35 are present inside the bearing. As shown in FIG. 14, for example, the communicating passage 21G is formed as a hole made by drilling, or as shown by 121G in FIG. 18, as a recess formed by metal mold or the like in the outer peripheral face of a sleeve 121.

The sleeve 21 is fixed to the base 28. The stator 30 is fixed to the base 28 so as to be across from the rotor magnet 29. If the base 28 is a magnetic material, the rotor magnet 29 generates an attraction force in the axial direction due to leaked magnetic flux. This results in the hub 27 being pressed in the direction of the thrust plate 24 by a force of approximately 10 to 100 grams.

Meanwhile, the hub 27 is fixed to the shaft 22. The rotor magnet 29, a disk 31, a spacer 32, a clamper 33, and a screw 34 are fixed to the hub 27.

The operation of the above-mentioned conventional hydrodynamic bearing-type rotary device shown in FIG. 13 will be described here through reference to FIGS. 14 to 17. In FIG. 14, the radial hydrodynamic groove 21B generates pressure under rotation, and rotates the shaft 22 in non-contact fashion. The first thrust hydrodynamic groove 23A, which has a herringbone pattern (FIG. 15), generates pressure between the flange 23 and the thrust plate 24, causing the rotational body composed of the hub 27, etc., to float and rotate. The combined force produced during bearing rotation, which is the combination of the pumping force (the vertical white arrow in the drawing) of the radial hydrodynamic groove 21B, which is in a herringbone pattern, and the pumping force (the horizontal white arrow in the drawing) of the second thrust hydrodynamic groove 23B, which is in a spiral pattern (see FIG. 16), conveys the oil 26 in the gap between the grooves and the tapered part 25B of the seal cap 25 through the bearing hole 21A and toward the flange 23 side in the direction of the black arrows in the drawing. The effect of a groove pattern designed in this way is that the oil 26 flows through the second thrust hydrodynamic groove 23B into the communicating passage 21l, and circulates back to the tapered part 25B of the seal cap 25, where it accumulates. As a result, the oil 26 circulates and is continuously supplied to the hydrodynamic parts, allowing the shaft 22 to rotate in a non-contact state with respect to the sleeve 21 and the thrust plate 24. Data can be recorded to or reproduced from the rotating recording disk 31 by a magnetic or optical head (not shown).

However, in FIG. 15, the first thrust hydrodynamic groove 23A is in a herringbone groove pattern, which is the most typical in this industry (see Patent Document 3: Japanese Laid-Open Patent Application No, 2001-173645). Accordingly, a low-pressure part is generated in which the pressure is lower than atmospheric pressure, as indicated by P (−) in the drawing. When a low-pressure part such as this is generated, the air dissolved in the oil 26 forms bubbles 35, which accumulate. When a pressure change occurs in the low-pressure part, there is the risk that the expanded air will flow into the second thrust hydrodynamic groove 23B, and the oil film will break up on the bearing face. If this happens, the desired bearing performance may not be obtained, or rubbing and seizure may occur. If the bearing rubs or seizes, this is a major problem because the entire rotary device or disk recording device will not operate at all. Furthermore, the radial hydrodynamic groove 21B shown in FIG. 14 has a single herringbone groove, but the same problem occurs when two are disposed in the axial direction. FIG. 17 is a schematic diagram of the circulation path of the oil 26 in a conventional example, and shows the flow of the oil 26 and the pumping pressure of the hydrodynamic grooves.

FIG. 17 shows the integrated shaft 22 and flange 23, and the thrust plate 24. The circulation path composed of a radial hydrodynamic part (the bearing hole 21A), a second thrust hydrodynamic part, the communicating passage 21G, and an oil reservoir is schematically represented by the outlined portion shown in the left half of the drawing. In the drawing, Pr and the long white arrow α (on the shaft diagram) represent the pumping pressure and direction of the radial hydrodynamic part. Pt and the short arrow β (on the flange diagram) represent the pumping pressure and direction of the second thrust hydrodynamic part. The other short arrow γ and the long arrow δ represent the pumping pressure and direction generated by the outer peripheral hydrodynamic groove, and the pumping pressure and direction generated by the inner peripheral hydrodynamic groove of the first thrust hydrodynamic part, respectively. It is shown that the combined force of the pumping pressures indicated by the arrows α and β circulates the oil overall in the direction of the arrow ε. The combined force in the directions of the arrows γ and δ pushes the oil to the outer periphery overall. Thus, a state is shown in which negative pressure tends to be generated in the inner peripheral part of the first thrust hydrodynamic part, and the air dissolved in the oil has expanded into the bubbles 35.

Patent Document 1: Japanese Laid-Open Patent Application No, H8-331796

Patent Document 2: Japanese Laid-Open Patent Application No, 2006-170344

### SUMMARY OF THE INVENTION

However, with the conventional hydrodynamic bearing-type rotary device discussed above, the first thrust bearing groove was a herringbone groove (23B) that generated a low-pressure part lower than atmospheric pressure. Therefore, air dissolved in the oil 26 accumulated as the bubbles 35 in the low-pressure part. When this low-pressure part underwent a pressure change, the air expanded and flowed into the second thrust hydrodynamic groove 23B, causing oil film separation on the bearing face, and this led to problems in that the desired bearing performance was not obtained, or the bearing rubbed and seized.

It is an object of the present invention to provide a hydrodynamic bearing that does not generate a low-pressure part near the center of the first thrust hydrodynamic groove, so stable performance is achieved, without oil film separation or seizing, and to provide a hydrodynamic bearing-type rotary device and a recording and reproducing apparatus equipped with this hydrodynamic bearing.

To solve the above problem, the hydrodynamic bearing and hydrodynamic bearing-type rotary device of the present invention comprise a shaft, a sleeve, a radial bearing face, and a first thrust bearing face. The sleeve has a bearing hole into which the shaft is inserted in an orientation that allows relative rotation, and which includes an open end and a closed end that is blocked off by a blocking member. The radial bearing face has a radial hydrodynamic groove formed in the outer peripheral face of the shaft and/or the inner peripheral face of the sleeve. The thrust bearing face has a first thrust hydrodynamic groove formed in the blocking member and/or the shaft. The first thrust hydrodynamic groove is a herringbone groove with a pump-in pattern. Also, when Ri is the innermost peripheral radius of the herringbone groove, Rm is the groove apex radius, and Ro is the outermost peripheral radius, (Rm−Ri)/(Ro−Ri) is 0.6 or less.

This allows the generation of a low-pressure part in the central portion of the thrust bearing part to be suppressed, so even if the bearing undergoes a pressure change and the air expands, that air will not push out the lubricant from the bearing face and cause oil film separation.

With the present invention, there is a hydrodynamic bearing and a hydrodynamic bearing-type rotary device in which a communicating hole is provided, the communicating hole and a radial hydrodynamic groove constitute a circulation path of the lubricant, and the lubricant circulates under pumping pressure (circulation force or conveyance force) from the hydrodynamic grooves, wherein a groove pattern is employed that makes it less likely that a low-pressure part will be generated in the thrust bearing. Therefore, even if the bearing should undergo a pressure change, there is no risk that bubbles accumulated in a low-pressure part will expand and cause oil film separation at the bearing face. Furthermore, the hydrodynamic groove located on the upstream side of the radial hydrodynamic groove part circulates the lubricant so that pressure is applied from the open end side of the sleeve toward the closed end side, and this prevents a low-pressure part from being generated in the thrust hydrodynamic groove part. Thus, oil film separation can be prevented in the radial hydrodynamic groove and thrust hydrodynamic groove.

### BRIEF DESCRIPTION OF THE DRAWINGS

FIG. 1 is a cross section of a hydrodynamic bearing pertaining to Embodiment 1 of the present invention;

FIG. 2 is a detailed cross section of a hydrodynamic bearing of FIG. 1;

FIG. 3 is a diagram illustrating a thrust hydrodynamic groove included in FIGS. 1 and 2;

FIG. 4 is a diagram of a lubricant circulation path in the hydrodynamic bearing of FIG. 1;

FIG. 5 is a detailed cross section of a hydrodynamic bearing of Embodiment 2 of the present invention;

FIG. 6 is a diagram of a lubricant circulation path in the hydrodynamic bearing of FIG. 5;

FIG. 7 is a diagram illustrating the surface area of a thrust bearing in a working example of the present invention;

FIG. 8 is a diagram illustrating the amount of float of the thrust bearing in a working example of the present invention;

FIG. 9 is a diagram illustrating the torque loss of the thrust bearing in the working example of the present invention;

FIG. 10 is a diagram illustrating the angular stiffness of the thrust bearing in the working example of the present invention;

FIG. 11 is a diagram illustrating the characteristics of a herringbone pattern groove in the working example of the present invention;

FIG. 12 is a cross section of a recording and reproducing apparatus equipped with a hydrodynamic bearing-type rotary device of the present invention;

FIG. 13 is a cross section of a first conventional hydrodynamic bearing;

FIG. 14 is a detailed cross section of the first conventional hydrodynamic bearing;

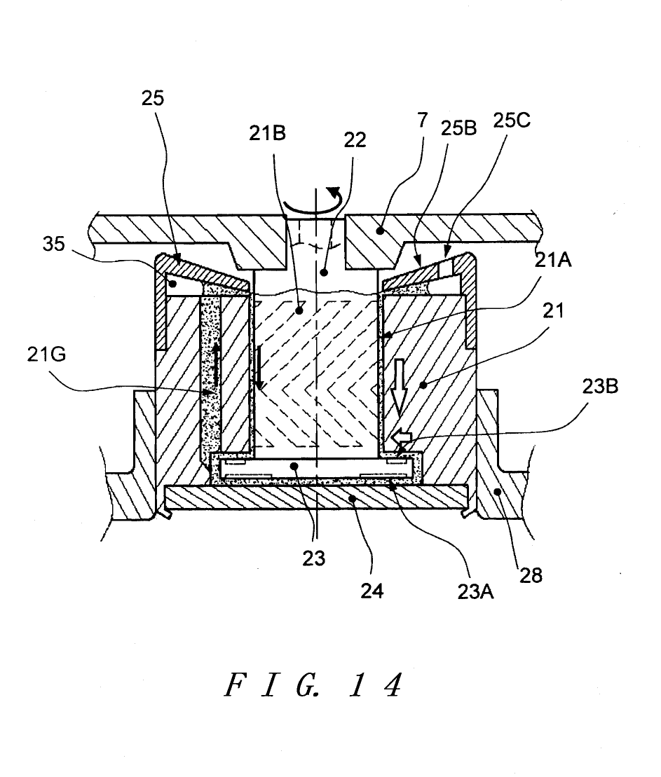

FIG. 15 is a diagram illustrating a conventional first thrust hydrodynamic groove;

FIG. 16 is a diagram illustrating a conventional second thrust hydrodynamic groove;

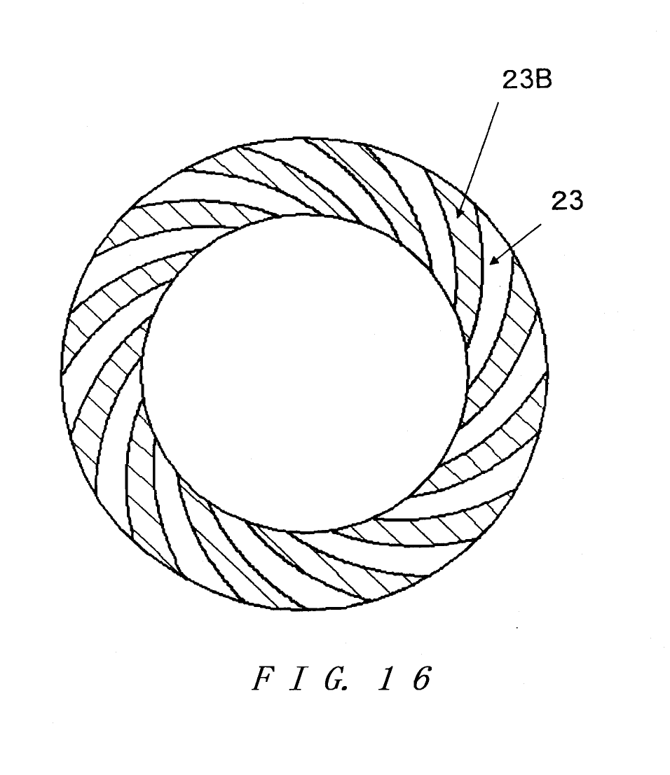

FIG. 17 is a diagram illustrating a conventional lubricant circulation path; and

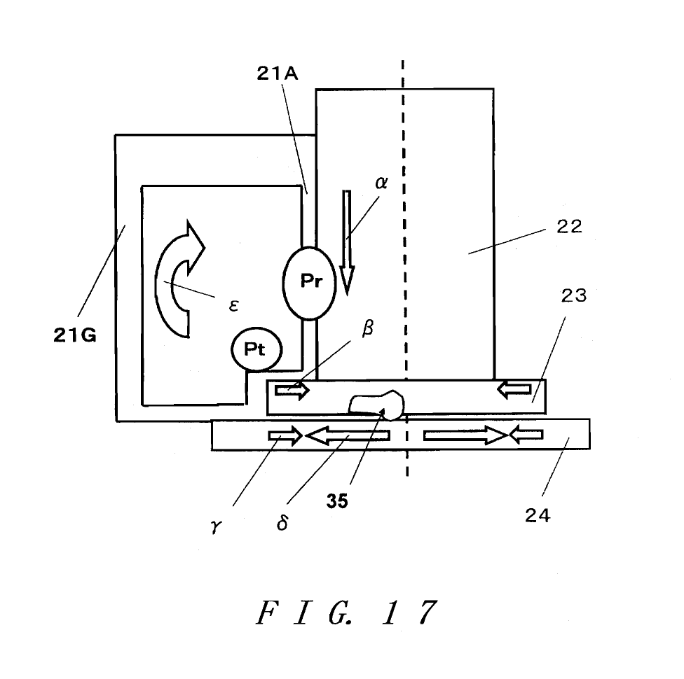

FIG. 18 is a detailed cross section of a second conventional hydrodynamic bearing.

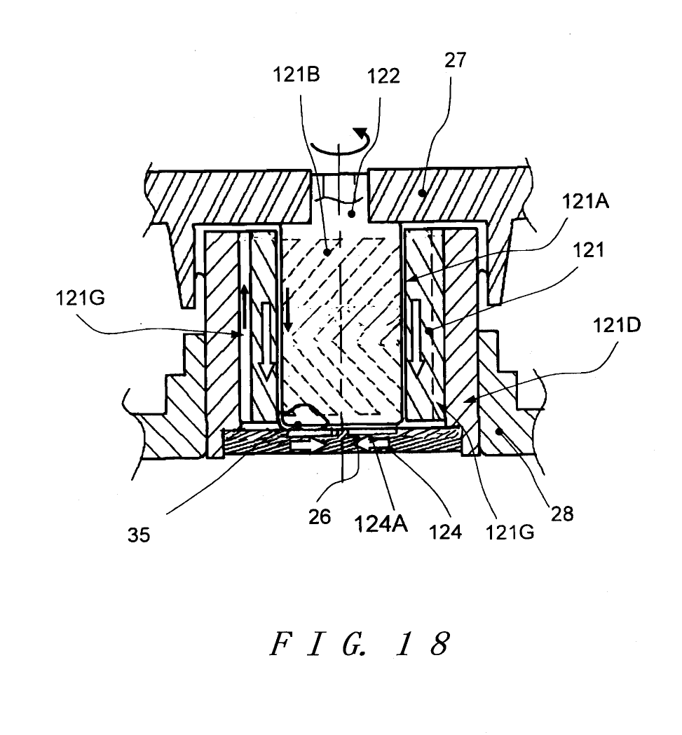

### DETAILED DESCRIPTION OF THE PREFERRED EMBODIMENTS

Embodiments that give specific best modes for carrying out the present invention will now be described along with the drawings.

### Embodiment 1

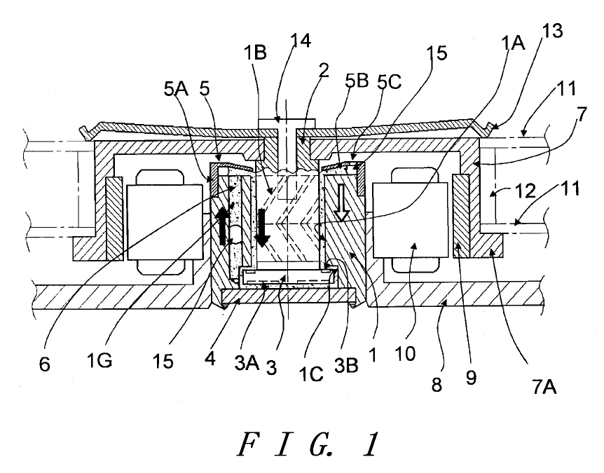

An example of the hydrodynamic bearing and hydrodynamic bearing-type rotary device pertaining to this embodiment will be described through reference to FIGS. 1 to 12.

As shown in FIG. 1, the hydrodynamic bearing-type rotary device of this embodiment comprises a sleeve 1, a shaft 2, a flange 3, a thrust plate 4, a seal cap 5, a lubricant 6 (such as oil, a high-fluidity grease, or an ionic liquid), a hub 7, a base 8, a rotor magnet 9, and a stator 10.

The shaft 2 is integrated with the flange 3, and is inserted in a rotatable state into a bearing hole 1A of the sleeve 1. The flange 3 is accommodated in a step part 1C of the sleeve 1. A radial hydrodynamic groove 1B comprising an asymmetrical herringbone patterned groove is formed in the outer peripheral face of the shaft 2 and/or the inner peripheral face of the sleeve 1. Meanwhile, a first thrust hydrodynamic groove 3A is formed in one of the opposing faces between the flange 3 and the thrust plate 4. A second thrust hydrodynamic groove 3B is formed in one of the opposing faces between the flange 3 and the sleeve 1. The thrust plate 4 is affixed to the sleeve 1 or the base 8. For example, the thrust plate is used as a blocking member. At least the bearing gaps near the hydrodynamic grooves 1B, 3A, and 3B are filled with the lubricant 6. Also, the entire pocket-shaped bearing gap formed by the sleeve 1, the shaft 2, and the thrust plate 4 is filled with the lubricant 6 as necessary. Oil, a high-fluidity grease, an ionic liquid, or the like can be used as the lubricant. The seal cap 5 is located at the upper end of the sleeve 1 and has a fixed part 5A attached to the sleeve 1 or the base 8, and a tapered part 5B, and a vent hole 5C. In the drawing, the entire seal cap 5 has a tapered shape, but just the inner peripheral part may be tapered. Alternatively, the seal cap 5 may not have a tapered shape, but an end face of the sleeve 1 may be tapered, A communicating hole 1G is provided as a communicating passage substantially parallel to the bearing hole 1A. The communicating hole 1G is provided so as to link a lubricant reservoir (oil reservoir) of the seal cap 5 with the area around the outer periphery of the flange 3. The communicating hole 1, the radial hydrodynamic groove 1B, and the second thrust hydrodynamic groove 3B are provided to as to be contiguous, and constitute the circulation path of the lubricant 6. Also, bubbles 35 are present inside the bearing. The communicating hole 1G may be formed as one or more holes made by drilling in the interior of the sleeve 1. Also, a vertical groove may be formed by mold working or the like on the outer peripheral part of the sleeve 1, and may be constituted as a communicating passage between the sleeve 1 and the inner peripheral part of the seal cap or the like covering the outer periphery of the sleeve 1.

The sleeve 1 is fixed to the base 8. The stator 10 is fixed to the base 8 so as to be across from the rotor magnet 9. If the base 8 is a magnetic material, the rotor magnet 9 generates an attraction force in the axial direction due to leaked magnetic flux. This results in the hub 7 being pressed in the direction of the thrust plate 4 by a force of approximately 10 to 100 grams. If the base 8 is a non-magnetic material, an attraction plate (not shown) is fixed on a base under the end face of the rotor magnet 9, allowing an attraction force to be generated. Meanwhile, the hub 7 is fixed to the shaft 2. The rotor magnet 9, a disk 11, a spacer 12, a damper 13, and a screw 14 are fixed to the hub 7.

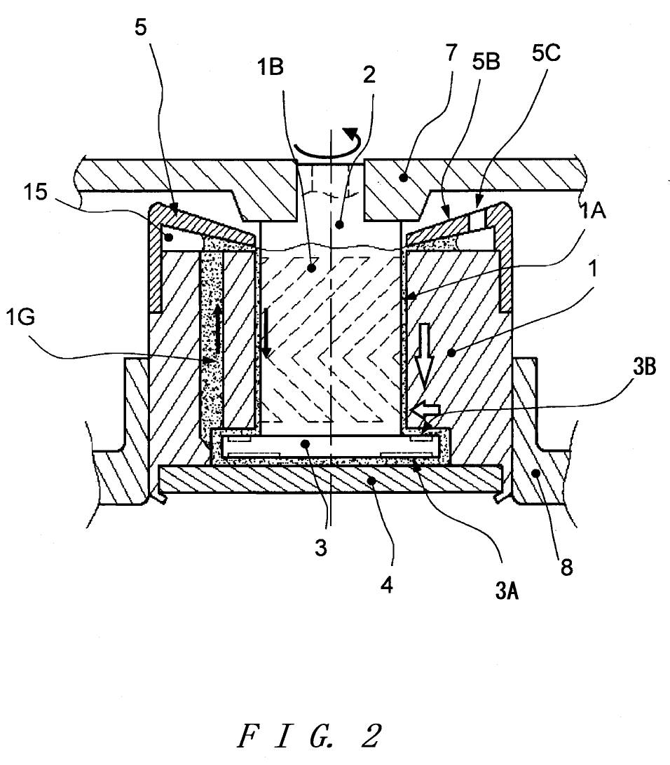

The operation of the hydrodynamic bearing and hydrodynamic bearing-type rotary device of this embodiment as shown in FIG. 1 will be described here through reference to FIGS. 2 to 4.

In FIG. 2, when the bearing begins to rotate, the radial hydrodynamic groove 1B scrapes the lubricant 6 together and generates pressure. This causes the shaft 2 to float with respect to the bearing hole 1A. The first thrust hydrodynamic groove 3A also generates pressure, causing the flange 3 to float and rotate in a non-contact fashion. The combined force produced during bearing rotation, which is the combination of the pumping force (the white arrow in the drawing) of the radial hydrodynamic groove 1B, which is a herringbone pattern, and the pumping force of the second thrust hydrodynamic groove 3B, which is in also in a herringbone pattern, conveys the lubricant 6 in the gap between the grooves and the tapered part 5B of the seal cap 5 through the bearing hole 1A and toward the outer peripheral face of the flange 3 in the direction of the black arrows in the drawing. The lubricant 6 flows through the second thrust hydrodynamic groove 3B into the communicating hole 1G, and then circulates back to the tapered part 5B of the seal cap 5, where it accumulates. That is, in this embodiment, the circulation path of the lubricant 6 is constituted so as to include the radial hydrodynamic groove 1B and the communicating hole 1G, and the second thrust hydrodynamic groove 3B and the lubricant reservoir are disposed so as to be in contact with each other. The flow of the lubricant is from the radial hydrodynamic groove 1B, through the second thrust hydrodynamic groove 3B, the communicating hole 1G, and the lubricant reservoir, to the radial hydrodynamic groove 1B, in that order. As a result, the lubricant 6 is supplied into the bearing gaps without interruption. Accordingly, the shaft 2 can be rotated in a non-contact state with respect to the sleeve 1 and the thrust plate 4. Thus, data can be recorded to or reproduced from the rotating recording disk 11 by a magnetic or optical head (not shown).

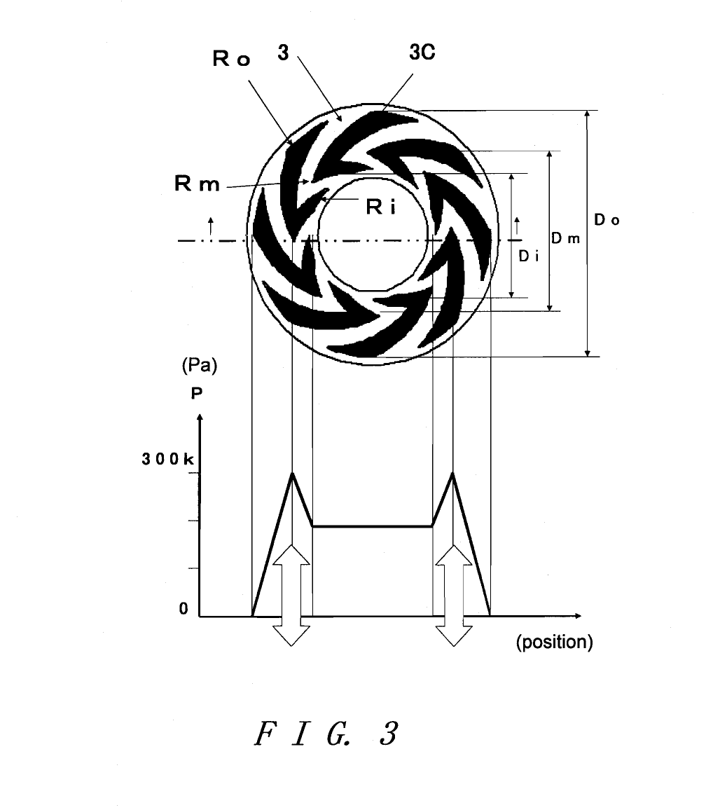

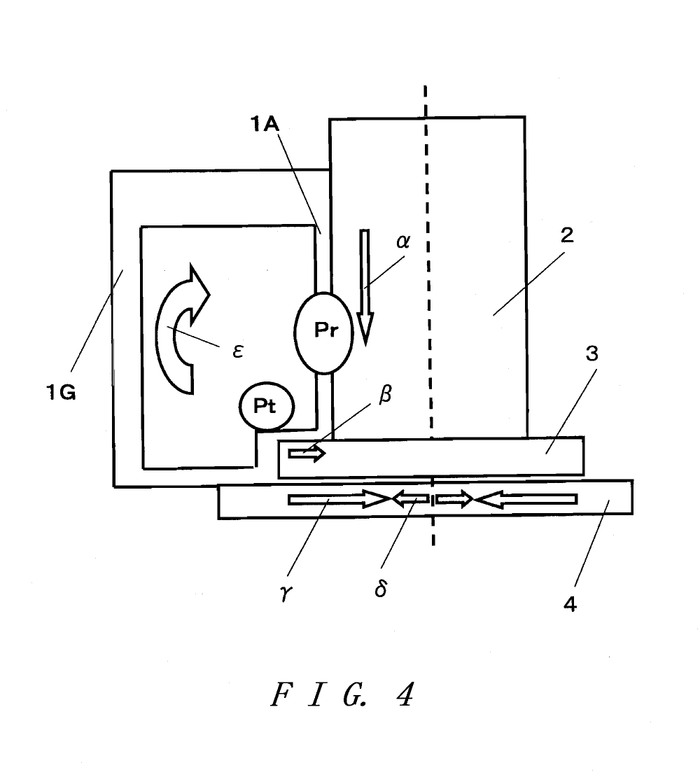

As shown in FIG. 3, in order not to generate negative pressure in the thrust hydrodynamic groove, it is effective to use a herringbone pattern with a sufficiently large inside diameter (Di) (also called a pump-in herringbone groove). If the inside diameter (Di) is large, the pressure distribution will be as shown in FIG. 3. Since the outer peripheral part, as seen from the groove apex, will be larger in size than the inner peripheral part, a pressure distribution can be achieved that will not result in a low-pressure part in the inner peripheral part of the thrust bearing. Thus, even if the bearing should undergo a pressure change, there is no risk that expanded air will cause oil film separation at the bearing face. Also, air does not accumulate in the interior of a first thrust hydrodynamic groove 3C (FIG. 3). Therefore, the air inside the bearing is completely discharged toward the outside of the bearing by the pumping force of the radial hydrodynamic groove 1B. It should go without saying that angular stiffness is high with a herringbone pattern because of the long span of the groove apexes that form the high-pressure part. FIG. 4 schematically illustrates the flow of oil and the pressure generated in the hydrodynamic grooves of the rotary device of FIG. 2.

FIG. 4 shows the integrated shaft 2 and flange 3, and the thrust plate 4. The circulation path composed of a radial hydrodynamic part (the bearing hole 1A), a second thrust hydrodynamic part, the communicating hole 1G, and a lubricant reservoir is schematically represented by the outlined portion shown in the left half of the drawing. In the drawing, Pr and the long white arrow α (on the shaft diagram) represent the pumping pressure and direction of the radial hydrodynamic part. Pt and the short arrow β (on the flange diagram) represent the pumping pressure and direction of the second thrust hydrodynamic part. The other arrows γ and δ represent the pumping pressure and direction generated by the outer peripheral hydrodynamic groove with a herringbone pattern, and the pumping pressure and direction generated by the inner peripheral hydrodynamic groove of the first thrust hydrodynamic part, respectively. With a spiral pattern, the pumping pressure in the direction of only the arrow y is generated. It is shown that the combined force of the pumping pressures indicated by the arrows α and β circulates the lubricant overall in the direction of the arrow ε. The combined force in the directions of the arrows γ and δ pushes the lubricant to the inner peripheral side overall, and a state is shown in which negative pressure tends not to be generated in the inner peripheral part of the first thrust hydrodynamic part.

The thrust hydrodynamic groove pattern shown in FIG. 3 generates sufficiently high pressure at the outside diameter part of the pattern, so even when a rotational moment is applied that would tilt the shaft 2, pressure can be generated that is sufficiently high with respect to this.

### Embodiment 2

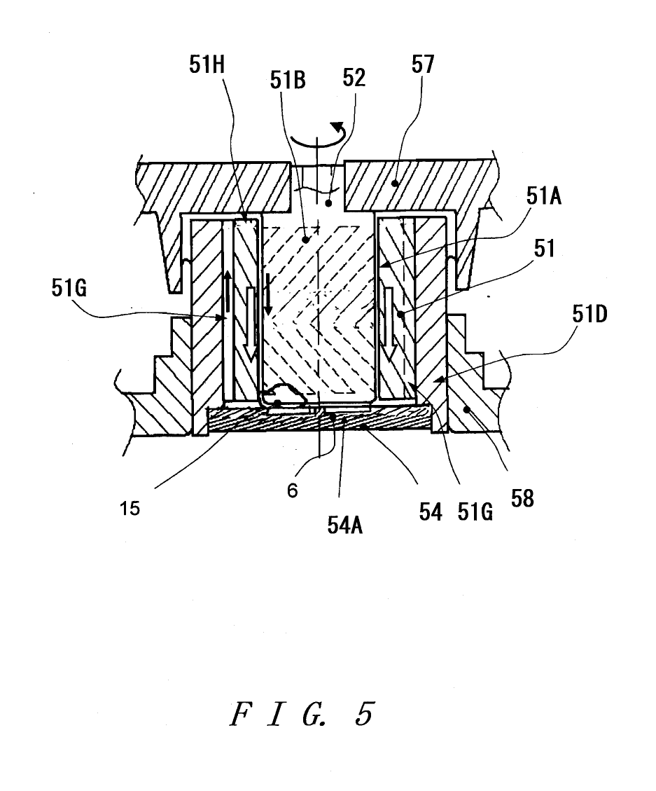

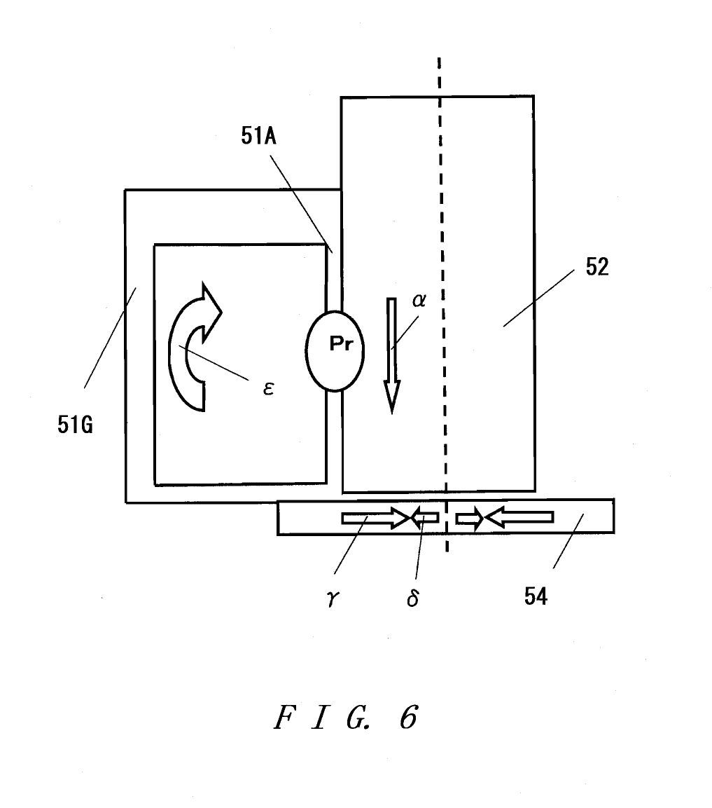

The hydrodynamic bearing-type rotary device pertaining to this embodiment will be described through reference to FIGS. 5 and 6.

As shown in FIG. 5, the hydrodynamic bearing-type rotary device in this embodiment has a sleeve 51, a second sleeve 51D, that is integrated with a second sleeve 51D, and further comprises a shaft 52, a thrust plate 54, a lubricant 6, a hub 57, and a base 58.

The shaft 52 is inserted in a rotatable state into a bearing hole 51A of the sleeve 51. A radial hydrodynamic groove 51B comprising an asymmetrical herringbone groove is formed in the outer peripheral face of the shaft 52 and/or the inner peripheral face of the sleeve 51. The thrust plate 54 has a first thrust hydrodynamic groove 54A with the same pattern as the herringbone groove with a sufficiently large inside diameter (Di) shown in FIG. 3. The thrust plate 54 is affixed to the sleeve 51, a second sleeve 51D or the base 58. Also, at least the bearing gaps near the hydrodynamic grooves 51B and 54A are filled with the lubricant 6. Also, the entire pocket-shaped bearing gap formed by the sleeve 51, the shaft 52, and the thrust plate 54 is filled with the lubricant 6 as necessary. A communicating hole 51G is provided so as to link the two ends of the radial hydrodynamic groove 51B. Bubbles 15 are present inside the bearing.

The operation of the hydrodynamic bearing-type rotary device shown in FIG. 5 will now be described through reference to FIGS. 5 and 6. When the hydrodynamic bearing-type rotary device begins to rotate, the thrust hydrodynamic groove 54A generates pressure (indicated by P in FIG. 3), causing the shaft 52 to float. Pressure is also generated by the radial hydrodynamic groove 51B, and the shaft 52 rotates in non-contact fashion. The radial hydrodynamic groove 51B is roughly in a herringbone pattern. The pattern of these grooves is designed so that the pumping force thereof will convey the lubricant 6 in the direction of the arrows in the drawings. The lubricant 6 repeatedly circulates, passing through the bearing hole 51A and then flowing into the communicating hole 51G.

The thrust hydrodynamic groove 54A in FIG. 5 here is the same as the herringbone groove with a sufficiently large inside diameter (Di) shown in FIG. 3. Because the inside diameter (Di) is large, the pressure distribution will be as shown in FIG. 3, and no low-pressure part will be generated by the thrust bearing. Therefore, even if the bearing should undergo a pressure change, there is no risk that expanded air will cause oil film separation at the bearing face. Also, air does not accumulate in the interior of the first thrust hydrodynamic groove 54A, so the air inside the bearing is completely discharged toward the outside of the bearing by the pumping force of the radial hydrodynamic groove 51B. Also, the pressure distribution is such that the pressure generated in the thrust bearing face during bearing rotation is sufficiently high at the outer peripheral portion of the groove pattern, and the pressure of the middle part does not reach a prominent height. Therefore, the moment stiffness generated at the flange 51 is high. FIG. 6 schematically illustrates the flow of the lubricant and the pressure generated in the hydrodynamic grooves of the bearing device of FIG. 5.

As a result, the lubricant 6 is supplied to the bearing gap, and the shaft 52 can rotate in a non-contact state with respect to the sleeve 51 and the thrust plate 54. Data can be recorded to or reproduced from the rotating recording disk 11 shown in FIG. 1 by a magnetic or optical head (not shown).

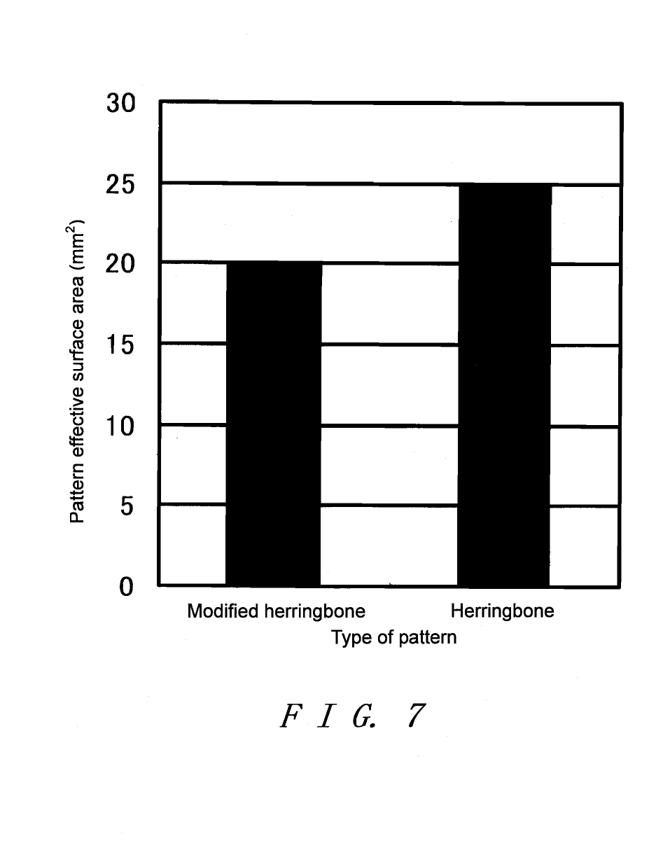

FIGS. 7 to 10 illustrate the performance of the hydrodynamic bearing (FIG. 1) of the above embodiment when the pattern of the first thrust hydrodynamic groove is varied. Here, the performance is shown for two kinds of thrust hydrodynamic groove. The second pattern is the herringbone pattern groove with a sufficiently large inside diameter (Di) shown in FIG. 3. Since the inside diameter (Di) is large here, the pressure distribution is as shown in FIG. 3, and no low-pressure part is generated by the thrust bearing part.

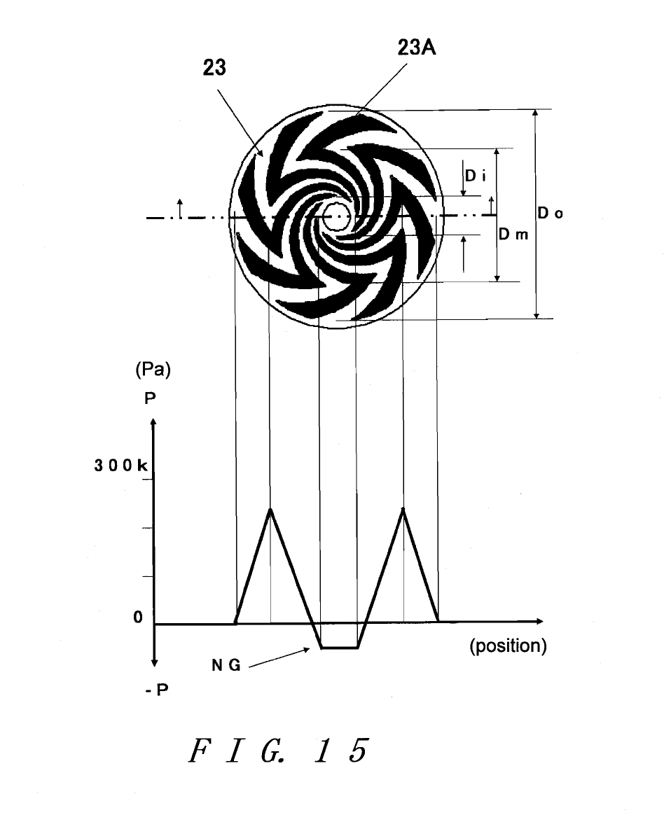

The first pattern is the herringbone groove pattern shown in FIG. 15. Here again, the inside diameter Di is 0.3 mm, and the hydrodynamic groove has the narrowest width that can be machined industrially, which is what determines the size.

First, FIG. 7 is a comparison of the effective surface area of each bearing pattern for the two kinds of thrust hydrodynamic groove (FIGS. 3 and 15). The bearing pattern effective surface area referred to here is the surface area of a ring-shaped pattern including a thrust hydrodynamic groove. The herringbone of the first pattern (“Herringbone” in FIG. 7) has a smaller inside diameter than the herringbone of the second pattern (“Modified herringbone” in FIG. 7), and therefore has a greater effective surface area.

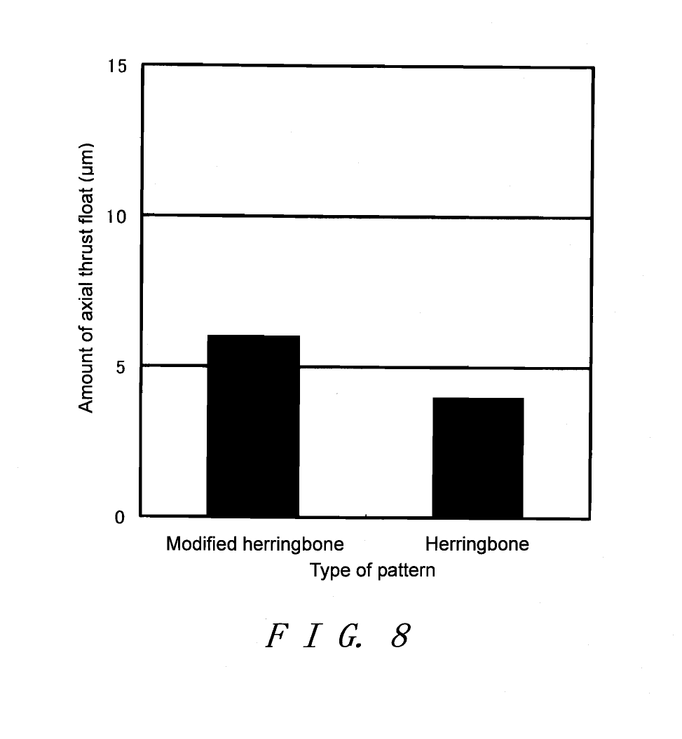

FIG. 8 is a comparison of the amount of axial thrust float in the thrust direction with the two kinds of thrust hydrodynamic groove (FIGS. 3 and 15). The herringbone of the first pattern has a smaller amount of float. The herringbone groove pattern is designed so that the inner peripheral portion of the groove pattern generates low pressure, while the outer peripheral portion generates high pressure. This is because the low pressure generating portion decreases float pressure and hinders float. A smaller amount of float is a drawback.

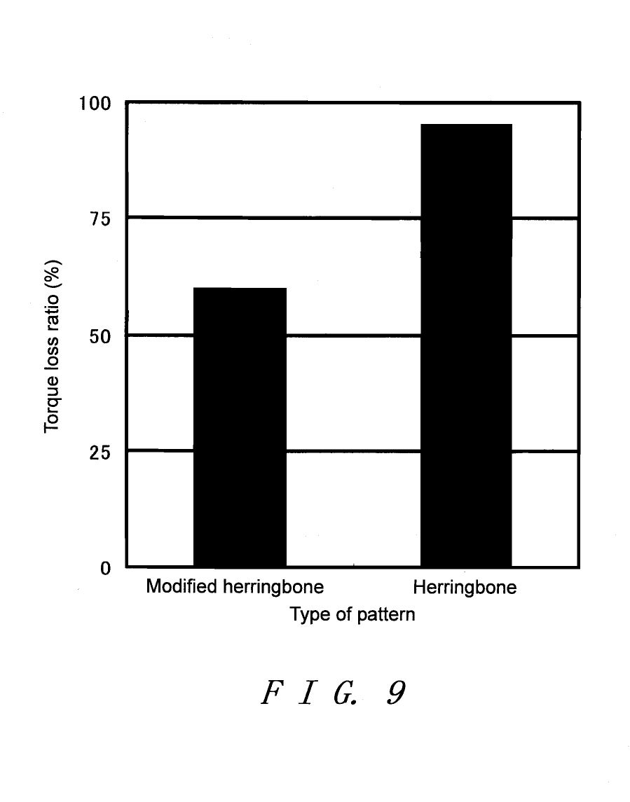

FIG. 9 is a comparison of the torque loss during steady-state rotation for the two kinds of thrust hydrodynamic groove (FIGS. 3 and 15). The herringbone of the first pattern has greater torque loss. However, this is because even though the bearing surface area is larger, the thrust float height is lower, so rotational resistance is greater, which is a drawback.

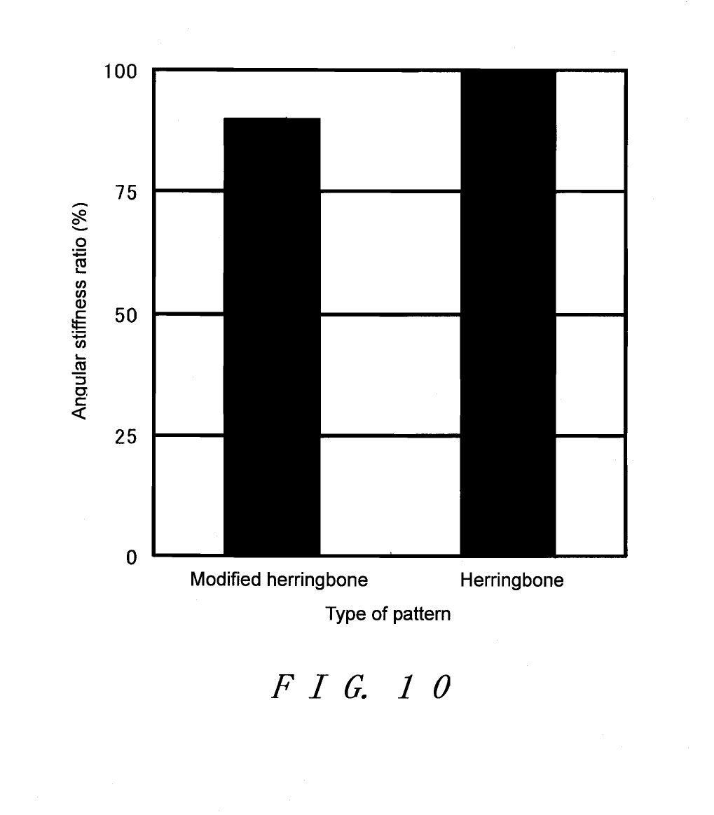

FIG. 10 is a comparison of the angular stiffness during steady-state rotation for the two kinds of thrust hydrodynamic groove (FIGS. 3 and 15). Because the herringbone of the first pattern has a larger effective surface area, its angular stiffness is higher.

Table 1 is a comparison of three bearing performances (Amount of axial thrust float, Torque loss ratio, Angular stiffness ratio) for the two kinds of thrust hydrodynamic groove shown in FIGS. 8 to 10. The pattern that has satisfactory performance in three categories and has no drawbacks is the second pattern (the “modified herringbone” in FIGS. 7 to 10; a herringbone pattern groove with a sufficiently large inside diameter (Di)). Tests conducted with bearings made from a transparent material revealed that numerous bubbles remained with the first pattern. With the second pattern, depending on the design of the pattern size, there were cases in which a small amount of bubbles remained in the middle part of the groove pattern. Here again it was found that this happens depending on the design condition of the pattern size, that is, that the size has to be optimized in design. In view of this, the second pattern was studied to find the design conditions that would produce the best pattern, with which no bubbles would remain on the inside.

TABLE 1

| | (2) Modified herringbone | (1) Herringbone |
|---|---|---|
| Pattern illustration | [symbol] | [symbol] |
| Amount of axial thrust | ◯ | X |
| floatt | | |
| Torque loss ratio | ◯ | X |
| Angular stiffness ratio | ◯ | ◯ |
| Low pressure generation | ◯ | X |
| Residual air | Δ~◯ | X |

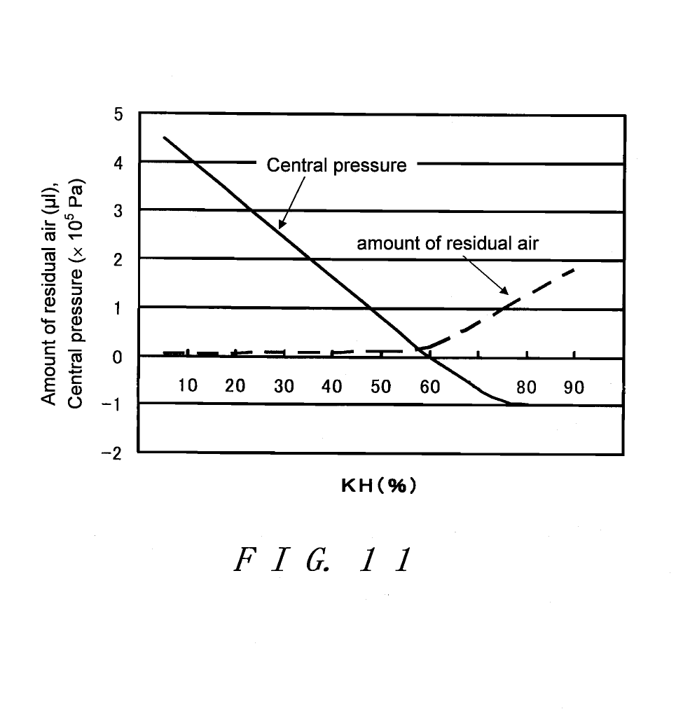

FIG. 11 is a graph of the pressure (Pa) of the central part of the hydrodynamic groove pattern and the volume of air remaining in the bearing of a hydrodynamic bearing obtained for observation and experimentation, for the second pattern (a herringbone pattern groove with a sufficiently large inside diameter (Di), when Ri is defined as the innermost peripheral radius of the groove pattern, Rm as the apex radius of the groove pattern, and Ro as the outermost peripheral radius of the groove pattern, and when the value of the function KH (KH=(Rm−Ri)/(Ro−Ri)) is varied from 0% to 100%. (The design here was different from the case discussed above for FIG. 3.)

In the graph, the solid line is the pressure at the middle part, and the dashed line is the amount of residual air.

With a thrust hydrodynamic groove having a herringbone pattern such as this, the results of a other numerical analysis reveal that if the design meets the conditions of the following Formula 2, the pressure in the center of the pattern will be 0 Pa, which is substantially the same as atmospheric pressure.

$$Rm = \sqrt{\frac{{Ro}^{2} + {Ri}^{2}}{2}} \qquad [ Formula 2 ]$$

The results of observation and experimentation also tell us that if the design is such that the dimension of Rm satisfies the conditions of Formula 1, no air will remain inside the thrust bearing face 3C, and air will be smoothly discharged.

$$Rm < \sqrt{\frac{{Ro}^{2} + {Ri}^{2}}{2}} \qquad [ Formula 1 ]$$

The equality of the above Formula 2 expresses conditions in which, when the numerical values of Ro and Ri satisfy the relationship of this Formula 2, the pumping pressure exerted outward by the hydrodynamic groove 3C in FIG. 3 from the outer periphery (Do) of the bearing face toward the apex (Dm) is equal to the pumping pressure exerted inward from the inner periphery (Di) toward the apex (Dm). In this case, since there is equilibrium between the inward pressure and outward pressure, the pressure on the inside of Di in FIG. 3 is 0 Pa, which is substantially equal to atmospheric pressure, and does not quite become the negative pressure (below atmospheric pressure) shown on the inside of Di in FIG. 15.

Also, when the numerical values of Ro and Ri satisfy the conditions of the above Formula 1, as shown in FIG. 3, the pumping pressure exerted outward by the hydrodynamic groove 3C from the outer periphery (Do) of the bearing face toward the apex (Dm) is lower than the pumping pressure exerted inward from the inner periphery (Di) toward the apex (Dm). Therefore, in FIG. 3, the pressure inside Di is higher than atmospheric pressure. As a result, bubbles are less likely to accumulate inside the thrust hydrodynamic groove 3C, and there is a higher probability that bubbles will accumulate closer to the outer periphery (Do) of the pattern. With circulation path of the lubricant provided in contact with this pattern, flow speed is forcibly imparted, so the bubbles move along this circulation path to the outside of the bearing.

Therefore, since the pressure inside the pattern changes suddenly above or below atmospheric pressure under conditions of the equality of Formula 2 or inequality of Formula 1, it is surmised that there is a critical point between the condition of the inequality of Formula 1 and the condition the equality of Formula 2.

Furthermore, as shown in FIG. 11, if the second pattern is designed so that the numerical value of the function KH((Rm−Ri)/(Ro−Ri)) is less than or equal to a specific value, the pressure generated in the center of the groove pattern will not become low, and it was found by observation that bubbles will not accumulate inside the bearing. More detailed observation confirmed that almost no bubbles remain inside if the numerical value of KH is set to 0.6 or lower.

In FIG. 11, the pressure of the center part (in FIG. 3, the portion within the pattern inside diameter Di) was found by other numerical calculation under conditions of varied values of the coefficient KH. Also, the amount of residual air is a numerical value obtained by observation of a transparent bearing.

The value of KH exhibits a critical point near 60%. This is because when the value of KH is 0.6 (60%) or less, no low pressure (pressure lower than atmospheric pressure) is produced in the center part of the thrust groove pattern 3C in FIG. 3, but a low-pressure part begins to be generated at over 0.6. Thus, it is believed that along with a low-pressure part being generated, the bubbles 15 suddenly flow in and adversely affect performance.

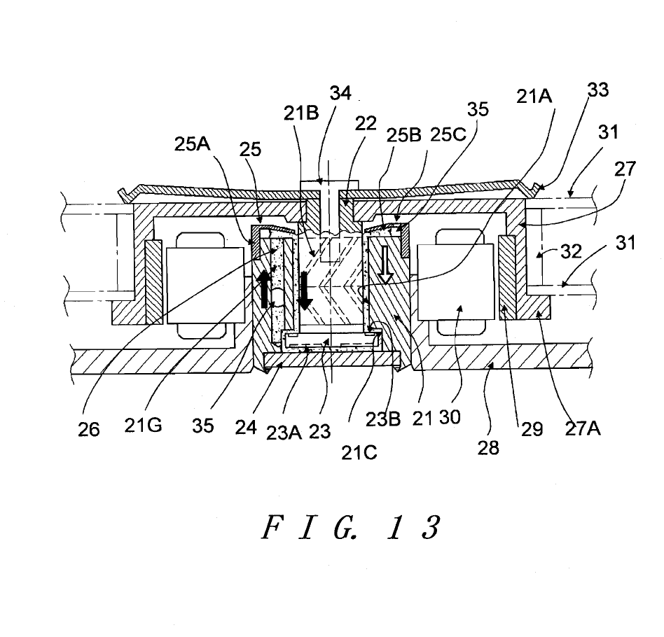

Also, when the value of KH is 0.6 or higher, and the hydrodynamic bearing or hydrodynamic bearing-type rotary device of this embodiment is used in the recording and reproducing apparatus shown in FIG. 13, for example, the recording defect rate increased in some cases. The cause of this seems to be that when the bubbles 15 enter the thrust bearing, there is a change in the float pressure or float height, and a good recording or reproduction state can no longer be maintained.

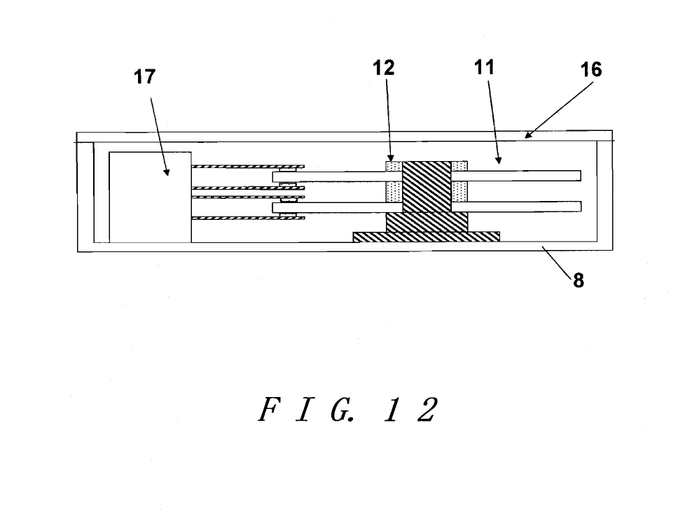

Also, the hydrodynamic bearing of this embodiment may in some cases be used in a humid environment when it is incorporated in the recording and reproducing apparatus shown in FIG. 12, for example. With a hydrodynamic bearing and a hydrodynamic bearing-type rotary device having the thrust bearing pattern 3C shown in FIG. 3, the flange 3 and the thrust plate 4 are usually made of a metal material having a rustproofing effect. However, with the conventional herringbone groove 23A shown in FIG. 15, the contact faces of these parts begin to rust slightly after extended operation (3000 hours or longer), and when more rust is produced, the rust particles can work their way into the bearing gap. With the hydrodynamic bearing of this embodiment, however, rusting is prevented. The likely reason for this is that in a high humidity environment, the effect of pressure in the thrust bearing part makes it less likely that water or water vapor will remain behind and produce rust on the metal surfaces.

Also, with the hydrodynamic bearing and hydrodynamic bearing-type rotary device of this embodiment, as shown in FIGS. 4 and 6, there is a circulation path composed of the radial hydrodynamic groove 1B and the communicating hole 1G, and there is a first thrust bearing in contact with this circulation path. In this case, if the groove pattern of the first thrust bearing is the herringbone groove pattern shown in FIG. 3, a tremendous effect is combined. That is, with a hydrodynamic bearing without a circulation path (not shown), even though bubbles can be kept from accumulating inside by employing the thrust groove pattern of this embodiment, the bubbles 15 merely moved to another place in the bearing. Therefore, there is the risk that the bubbles will find their way back to the bearing face, but by combining the thrust bearing with a circulation path, any bubbles inside the bearing can be completely discharged to outside of the bearing. Also, bubbles can be discharged even more completely by providing the vent hole 5C, which communicates with the outside air, next to the circulation path including the radial hydrodynamic groove 1B and the communicating hole 1G.

If the hydrodynamic bearing-type rotary device of this embodiment is incorporated into the recording and reproducing apparatus shown in FIG. 12, then when this device is used in a compact notebook personal computer or a mobile device, there will be no drop in performance when the product is used at high altitude (on a mountain or in the air), which means that the high performance of the product can be utilized over a wider range of environments.

By thus designing the groove pattern of the thrust bearing so that no bubbles remain in the bearing, a low-pressure part is not generated by the thrust bearing. Thus, even if the environment in which the product is used should change, and the inside of the bearing should undergo a pressure change, there will be no danger that air will expand and cause oil film separation on the bearing face. Also, the pressure generated at the thrust bearing face during rotation of the bearing has a distribution such that the pressure is sufficiently high at the outer peripheral portion of the groove pattern. Therefore, there is high angular stiffness of the thrust bearing part generated between the groove and the thrust plate, so a hydrodynamic bearing-type rotary device with good performance and a long service life can be obtained.

Furthermore, in this embodiment, the sleeve 1 may be made from pure iron, stainless steel, a copper alloy, an iron-based sintered metal, or the like. The shaft 2 may be made from stainless steel, high-manganese chromium steel, or the like, and its diameter may be from 2 to 5 mm. The lubricant 6 is a low-viscosity ester-based oil.

In FIGS. 1, 2, and 5, the communicating holes 1G and 51G were provided at only one location, but the same effect will be obtained by providing the communicating holes at a plurality of sites, rather than just one.

Also, as shown in FIG. 12, a highly reliable recording and reproducing apparatus can be obtained by applying the above-mentioned hydrodynamic bearing and hydrodynamic bearing-type rotary device to a recording and reproducing apparatus. In the drawings, a lid 16 and a head actuator unit 17 are shown.

### INDUSTRIAL APPLICABILITY

The hydrodynamic bearing pertaining to the present invention affords greatly enhanced bearing reliability, and is therefore useful in recording and reproducing apparatuses and the like in which this hydrodynamic bearings is used.

1. A hydrodynamic bearing, comprising:
a shaft;
a sleeve having a bearing hole into which the shaft is inserted in an orientation that allows relative rotation, and which includes an open end and a closed end that is blocked off by a blocking member;
a radial bearing face in which a radial hydrodynamic groove is formed in the outer peripheral face of the shaft and/or the inner peripheral face of the sleeve; and
a first thrust bearing face in which a first thrust hydrodynamic groove is formed in the blocking member and/or the shaft,
wherein the first thrust hydrodynamic groove is a herringbone groove with a pump-in pattern, and satisfies the following relational formula when Ri is the innermost peripheral radius of the herringbone pattern, Rm is the groove apex radius of the herringbone pattern, and Ro is the outermost peripheral radius of the herringbone pattern:
$$Rm < \sqrt{\frac{{Ro}^{2} + {Ri}^{2}}{2}} \qquad [ Formula 1 ]$$

2. The hydrodynamic bearing according to claim 1, wherein for the innermost peripheral radius Ri, the groove apex radius Rm, and the outermost peripheral radius Ro of the herringbone pattern, (Rm−Ri)/(Ro−Ri) is 0.6 or less.

3. The hydrodynamic bearing according to claim 1, further comprising at least one communicating passage that is located substantially parallel to the bearing hole and whose two ends communicate with the radial hydrodynamic groove,
at least the communicating passage and the radial hydrodynamic groove constitute a lubricant circulation path,
the first thrust hydrodynamic groove is provided in contact with the circulation path,
a lubricant is injected into the circulation path, and
the radial hydrodynamic groove has an asymmetrical groove pattern that generates a conveyance force that conveys the lubricant from the open end side of the sleeve toward the closed end side.

4. The hydrodynamic bearing according to claim 1,
further comprising a second thrust hydrodynamic groove that generates pressure in the opposite direction from that of the pressure imparted by the first thrust hydrodynamic groove to the shaft,
the circulation path includes the second thrust hydrodynamic groove, at least one of the communicating passages, and at least one of the radial hydrodynamic grooves.

5. The hydrodynamic bearing according to claim 4,
the shaft has a flange part on the closed end side of the sleeve, and
the flange part has a first thrust bearing face on the closed side face, and a second thrust bearing face on the opposite side face.

6. The hydrodynamic bearing according to claim 1,
the asymmetrical groove pattern of the radial hydrodynamic groove includes a herringbone pattern groove in which the open end side of the bearing hole is longer than the closed end side, with the groove apex as a boundary as viewed in the axial direction.

7. The hydrodynamic bearing according to claim 1, further comprising:
a lubricant reservoir provided at a location in contact with the circulation path; and
a vent hole that communicates with the lubricant reservoir and opens to the outside.

8. The hydrodynamic bearing according to claim 2,
further comprising at least one communicating passage that is located substantially parallel to the bearing hole and whose two ends communicate with the radial hydrodynamic groove,
at least the communicating passage and the radial hydrodynamic groove constitute a lubricant circulation path,
the first thrust hydrodynamic groove is provided in contact with the circulation path,
a lubricant is injected into the circulation path, and
the radial hydrodynamic groove has an asymmetrical groove pattern that generates a conveyance force that conveys the lubricant from the open end side of the sleeve toward the closed end side.

9. The hydrodynamic bearing according to claim 2,
further comprising a second thrust hydrodynamic groove that generates pressure in the opposite direction from that of the pressure imparted by the first thrust hydrodynamic groove to the shaft,
the circulation path includes the second thrust hydrodynamic groove, at least one of the communicating passages, and at least one of the radial hydrodynamic grooves.

10. The hydrodynamic bearing according to claim 3,
further comprising a second thrust hydrodynamic groove that generates pressure in the opposite direction from that of the pressure imparted by the first thrust hydrodynamic groove to the shaft,
the circulation path includes the second thrust hydrodynamic groove, at least one of the communicating passages, and at least one of the radial hydrodynamic grooves.

11. The hydrodynamic bearing according to claim 2,
the asymmetrical groove pattern of the radial hydrodynamic groove includes a herringbone pattern groove in which the open end side of the bearing hole is longer than the closed end side, with the groove apex as a boundary as viewed in the axial direction.

12. The hydrodynamic bearing according to claim 3,
the asymmetrical groove pattern of the radial hydrodynamic groove includes a herringbone pattern groove in which the open end side of the bearing hole is longer than the closed end side, with the groove apex as a boundary as viewed in the axial direction.

13. The hydrodynamic bearing according to claim 4,
the asymmetrical groove pattern of the radial hydrodynamic groove includes a herringbone pattern groove in which the open end side of the bearing hole is longer than the closed end side, with the groove apex as a boundary as viewed in the axial direction.

14. The hydrodynamic bearing according to claim 2, further comprising:
a lubricant reservoir provided at a location in contact with the circulation path; and
a vent hole that communicates with the lubricant reservoir and opens to the outside.

15. The hydrodynamic bearing according to claim 3, further comprising:
a lubricant reservoir provided at a location in contact with the circulation path; and
a vent hole that communicates with the lubricant reservoir and opens to the outside.

16. The hydrodynamic bearing according to claim 4, further comprising:
a lubricant reservoir provided at a location in contact with the circulation path; and
a vent hole that communicates with the lubricant reservoir and opens to the outside.

17. The hydrodynamic bearing according to claim 5, further comprising:
a lubricant reservoir provided at a location in contact with the circulation path; and
a vent hole that communicates with the lubricant reservoir and opens to the outside.

18. The hydrodynamic bearing according to claim 6, further comprising:
a lubricant reservoir provided at a location in contact with the circulation path; and
a vent hole that communicates with the lubricant reservoir and opens to the outside.

19. A hydrodynamic bearing-type rotary device comprising the hydrodynamic bearing according to claim 1.

20. A recording and reproducing apparatus comprising the hydrodynamic bearing-type rotary device according to claim 19.
